(19) United States
(12) Patent Application Publication
(10) Pub. No.: US 2012/0299734 A1
(43) Pub. Date: Nov. 29, 2012

(54) TEMPERATURE SENSOR DEVICE AND METHOD THEREOF

(76) Inventors: Thomas Holthaus, Lewisville, TX (US); John G. Larson, Austin, TX (US)

(21) Appl. No.: 13/475,261

(22) Filed: May 18, 2012

Related U.S. Application Data
(60) Provisional application No. 61/490,702, filed on May 27, 2011.

(51) Int. Cl. G01K 1/02; G08B 21/18

(52) U.S. Cl. 340/584; 116/216

(57) ABSTRACT

A temperature sensitive probe includes a portion to be inserted into food, and a pop-out portion having a primary indicator. The primary indicator is retained at a retained position by the release mechanism responsive to a temperature of the probe portion being below a predefined temperature, and extends to a position at least 0.7 inches beyond the retained position in response to the release mechanism releasing the indicator.

### CROSS-REFERENCE TO RELATED APPLICATION

The present application is a non-provisional of U.S. Provisional Application No. 61/490,702, entitled “TEMPERATURE SENSOR DEVICE AND METHOD THEREOF” filed on May 27, 2012, the entirety of which is herein incorporated by reference.

### BACKGROUND

1. Field of the Disclosure

The present disclosure deals with temperature sensing, and more particularly with a pop out type temperature sensor.

2. Description of the Related Art

Pop-up temperature sensing devices are well known for use in poultry products and often come pre-inserted into various poultry products. Pop-up temperature sensors are used to ensure a desired temperature is obtained within poultry to kill harmful bacteria. Such pop-up devices are often difficult to observe and can require the opening of an oven door or turning on a light source, such as in an oven, in order to view.

### BRIEF DESCRIPTION OF THE DRAWINGS

The present disclosure may be better understood, and its numerous features and advantages made apparent to those skilled in the art by referencing the accompanying drawings.

FIG. 1 illustrates a temperature sensitive device in accordance with a specific embodiment of the present disclosure.

FIG. 2 illustrates a specific embodiment of the device of FIG. 1 in an extended position in accordance with a specific embodiment of the disclosure.

FIG. 3 illustrates a particular set of temperature sensitive devices in accordance with a specific embodiment of the disclosure.

FIG. 4 illustrates a specific set of temperature sensitive devices in accordance with a specific embodiment of the disclosure.

FIG. 5 illustrates a specific set of temperature sensitive devices in accordance with a specific embodiment of the disclosure.

FIG. 6 illustrates a temperature sensitive device in use over heat source in accordance with a specific embodiment of the disclosure.

FIG. 7 illustrates a temperature sensitive device in accordance with a specific embodiment of the disclosure.

FIG. 8 illustrates a temperature sensitive device in accordance with a specific embodiment of the disclosure.

The use of the same reference symbols in different drawings indicates similar or identical items.

### DETAILED DESCRIPTION OF THE DRAWINGS

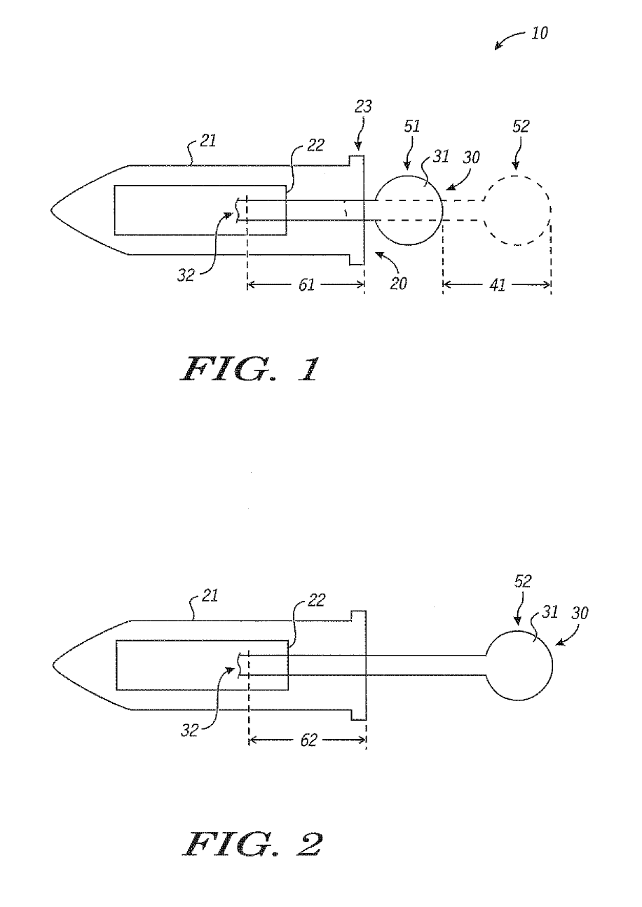

FIG. 1 illustrates a specific embodiment of a temperature sensitive device 10. The temperature sensitive device 10 includes a body portion 20 (probe portion) and an indicator portion 30 (pop-out portion). The body portion 20 includes an outer body 21, and a release mechanism 22 located within the outer body 21. The outer body 21 is pointed at a proximate end to facilitate being inserted into food, and a flange 23 at a distal end to facilitate insertion of the device to a proper distance. The indicator portion 30 includes a primary indicator 31, and an extension portion 32. The primary indicator 31 as a dimension of at least 0.5 inches. The indicator portion 30 will be maintained in a retained position 51 by the release mechanism 22 so long as a temperature of the release mechanism 22 is below a predefined temperature. The indicator portion 30 moves, e.g., pops out, a distance 41 to an extended position 52 when released by the release mechanism 22, which occurs upon the release mechanism reaching the predefined temperature. The distance 41 is at least 0.7 inches. The release mechanism 22 can be any type of commercially available or proprietary release mechanism capable of being calibrated to predefined temperatures consistent with the present disclosure.

As further illustrated in FIG. 1, the extension portion 32 includes an extendable portion having a length 61 that is equal to the distance 41. The extendable portion of the extension portion 32 is that portion of the extension portion 32 that extends beyond the outer body 21 when the indicator 30 is extended upon being released by the release mechanism 22. A portion of the extension portion 32 that is to the left of length 61, as illustrated at FIG. 1, is associated is a non-extendable portion of the extension portion 32 that will, therefore, not extend beyond the outer body 21 when the indicator 30 is extended.

In operation, the probe portion 20 of the temperature sensitive device 10 is inserted into food up to a location defined by flange 23. In particular, the temperature sensitive device 10 is useful for use with food prepared in environments having impaired visibility due to smoke and in environments that do not allow users sufficiently close access to food being cooked due to distance, such as can result from a high temperature heat source. The indicator portion 30 will remain in retained position 51 in response to a temperature of the probe portion 20 remaining below a predefined temperature. When the predefined temperature is exceeded, the indicator portion 30 pops-out to the extended position 52 indicating a desired level of doneness has been reached. The temperature sensor device 10 can be a single use device that is disposable after one use, or a multiple use device that is resettable by a user.

The predefined temperature at which the release mechanism 22 releases the indicator 30 is selected based upon an expected temperature at the outer body 21 that corresponds to a desired level of doneness for a particular type of meat. For example, the temperature sensor device 10 can be calibrated for use in beef steaks, referred to herein as “steaks,” wherein the predefined temperature of the release mechanism is selected to release at a temperature of 130 degrees F. to indicate that a beef steak at which the device 10 is inserted is considered rare; to release at a temperature of 145 degrees F. to indicate that a beef steak at which the device 10 is inserted is considered medium rare; to release at a temperature of 160 degrees F. to indicate that a beef steak at which the device 10 is inserted is considered medium; to release at a temperature of 165 degrees F. to indicate that a beef steak at which the device 10 is inserted is considered medium well; to release at a temperature of 170 degrees F. to indicate that a beef steak at which the device 10 is inserted is considered well. For simplicity of discussion, it is presumed that the temperature of release mechanism 22 and the temperature at the outer body 21 is the same. However, one skilled in the art will appreciate that a temperature difference will exist based upon various heat transfer characteristics of a particular temperature sensing device 10, and that the temperatures indicated above can be either temperatures at the release mechanism, or expected temperatures at the outer portion of the device 10.

It will be appreciated, that a predefined temperature associated with a particular level of doneness can vary based upon specific characteristics of the steak being cooked. For example, the temperature that corresponds to particular level of doneness can vary from steak to steak based upon its thickness. As another example, a temperature that corresponds to a particular level of doneness can be different between ground steak and un-ground steak. Therefore, a particular temperature sensor device that corresponds to a particular level of doneness may need to be calibrated for a particular beef steak characteristic, such as thickness. For example, one temperature at the center of a steak having a thickness of ¾ of an inch may correspond to a medium-done steak, while a different temperature at the center of a steak of the same type having a thickness of 1 inch or greater would correspond to a medium-done steak. Similarly, cuts of steak having thickness in excess of 1 inch may have yet a different temperature profile requiring different predefined temperatures that correspond to desired levels of doneness.

FIG. 2 illustrates the temperature sensitive device 10 after the indicator portion 30 has been released. In accordance to the particular embodiment, the primary indicator 31 of each temperature sensitive device that is calibrated to the same temperature has a shape that is different from the shape of the primary indicator 31 of temperature sensitive devices calibrated to different temperatures. In a particular embodiment, the difference between the shapes of indicators 31 for differently calibrated temperature sensor devices is selected to be significant enough to be visibly distinguishable from each other indicator 31 when inserted into steaks being cooked over an open flame, on a grill, such as a charcoal grill, or a gas grill, and the like. Making the distance that the primary indicator 31 extends a significant distance and making primary indicators visibly different based upon a calibration temperature, a user can easily determine the state and type of sensor even when a steak is being cooked in an environment having high temperatures and heavy smoke. Similarly, making the size of the primary indicator 31 to be relatively large makes the device more readily viewable. These are advantages over prior pop-up temperature sensor devices, which have very small indicators, with little or no portion that is visible prior to being extended, and therefore difficult to see in a grilling environment. Therefore, in according with this specific embodiment, not only does the extendable portion pop out by a distance greater than 0.7 inches, it also has a unique identifier allowing the predefined temperature associated with a particular temperature sensitive device to be readily determinable when inserted into food and in a retained position. Various indicators of different shapes can be used for each predefined temperature.

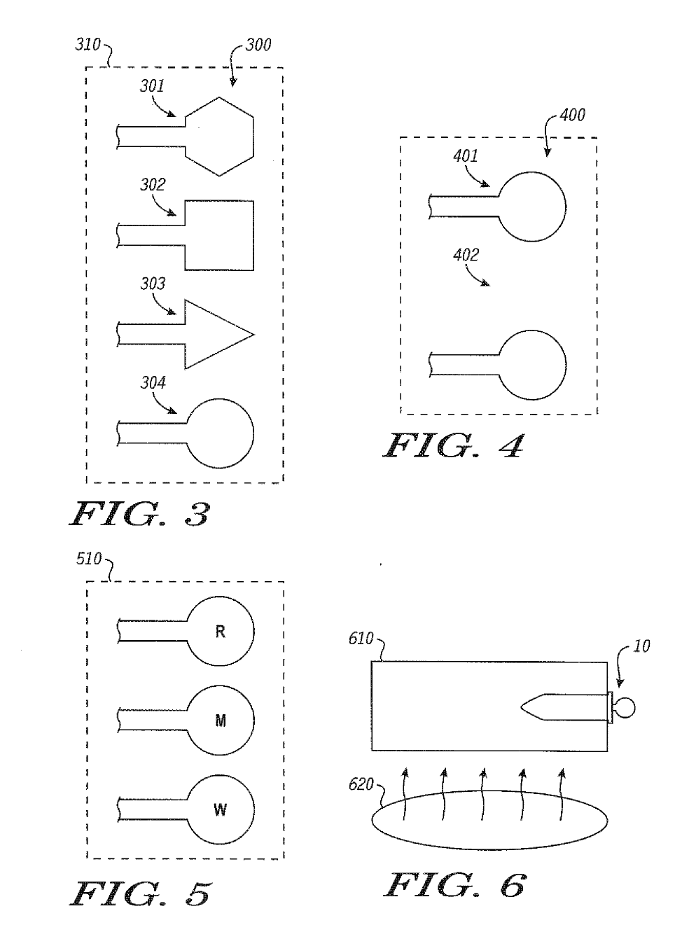

FIGS. 3-5 illustrate various sets of temperature sensitive devices. A first set 300 of temperature sensitive devices can be commonly packaged in a package 310. The only portion of each temperature sensitive device illustrated at FIGS. 3-5 is the primary indicator 31 of each temperature sensitive device.

Referring to FIG. 3, four different primary indicator shapes are indicated including, a circular 304, a triangular shape 303, a square shape 302, and a hexagonal shape 301. In accordance with the particular embodiment, each of these shapes is associated with a different predefined temperature, each of which is associated with a corresponding different predefined level of doneness. For example, the hexagonal shape 301 can be associated with a predefined temperature that represents a meat such as beef, cooked to a doneness of well done. The square 302 could represent the steak cooked to a doneness of medium-well. The triangular shape 303 could represent the steak cooked to a doneness of medium, while the circle 304 could be cooked to a doneness identified as medium rare.

Other primary indicators besides shapes can be used to differentiate between temperature sensitive devices associated with different temperatures. For example, FIG. 4 illustrates a set of temperature sensitive devices 400 including a first temperature sensor device having a indicator 401 having a first color, indicated as color 1, and a second temperature sensitive device associated with a different temperature having an indicator associated with a different color listed as color 2. For example, according to a particular embodiment, a medium-rare steak primary indicator could have a color indicator of green, a medium steak primary indicator could be associated with a color indicator of yellow, and a temperature sensitive device to be associated with a well done steak could have a color indicator that is red. Again, the set of temperature sensitive devices having different predefined temperatures are commonly packaged in a package 110.

FIG. 5 illustrates yet another embodiment of unique primary indicators for each temperature of a set of predefined temperatures that are based upon alphanumeric values. In the embodiment of FIG. 5, the alphanumeric indicator can be stamped onto an indicator, can be a cut space within the indicator, or could even be defined by the perimeter shape of the indicator (not shown). Again, the set of temperature sensitive devices are packaged in a common package 510.

Each of the package sets of FIGS. 3-5 can provide pop-out temperature sensitive devices of varying temperature sensitivities that correspond to varying desired levels of doneness for steaks. In addition, the temperature sensitive devices of a package can be calibrated to a specific steak characteristic. For example, a set of temperature sensitive devices can be calibrated for steaks of a particular thickness, e.g., less than 1 inch, 1-2 inches, greater than 2 inches, of a particular type, e.g., ground or un-ground, the like, and combinations thereof.

FIG. 6 illustrates a specific embodiment of a temperature sensitive device of the type described herein in use. In particular, the temperature sensitive device 10 is inserted into a steak 610, which resides over a heat source 620. According to a specific embodiment, the heat source 620 is a grill, such as a charcoal grill, or a gas grill whereby flames and smoke are commonly expected during the cooking process. Upon reaching a desired level of doneness, the temperature sensor device 10 will pop-out, away from the edge of the steak in a direction perpendicular an edge of the steak, thereby allowing the steak to be flipped while the indicator is inserted. By allowing for a temperature sensitive device that pops out by at least 0.7 inches, it can be readily determined when a desired level of doneness has been obtained.

FIG. 7 illustrates an alternate embodiment of a temperature sensor device in accordance with this present disclosure inserted into a steak 710. The temperature sensing device 20 of FIG. 7 includes a device capable of sensing multiple temperatures. This is specifically illustrated at FIG. 7 as a dual probe device having one of the two pop-up portions extended (popped out). In accordance with the specific embodiment the temperature sensitive device includes a pop out portion 721 which has a predefined pop out temperature that is indicative of when a steak being cooked is ready to be turned. Therefore, the steak as indicated in FIG. 7 is ready to be turned because the pop out portion 721 is in an extended position. Upon turning the steak the steak will continue to be cooked until the pop out portion 722 extends thereby indicating the steak is completed. While the temperature sensitive device 720 is illustrated to have two separate probe portions that correspond to different indicator portions, it will be appreciated that a single probe capable of indicating two different temperatures is also possible.

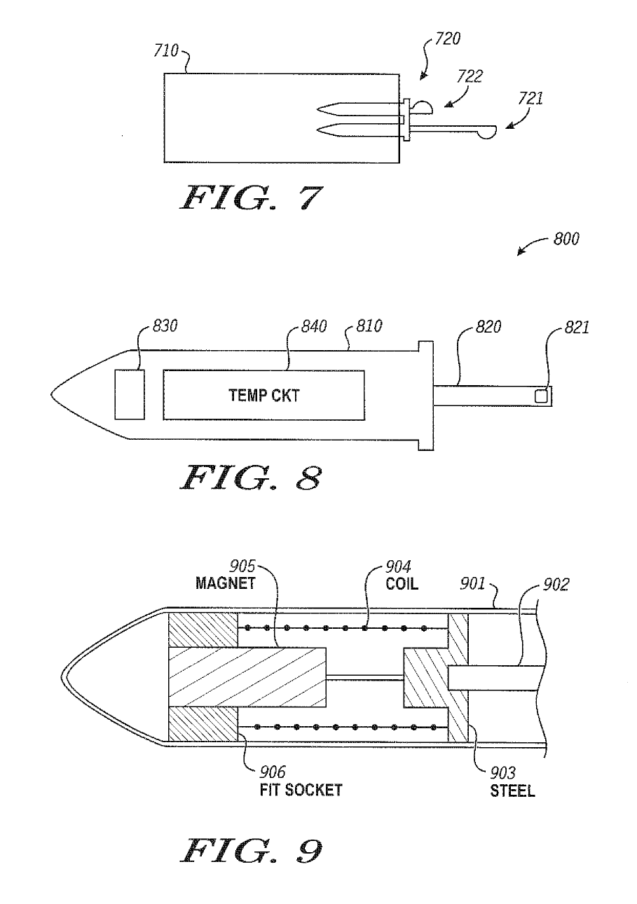

FIG. 8 illustrates another embodiment of the present disclosure, wherein a temperature sensitive device 800 includes temperature sensitive circuitry 840 that detects one or more predefined temperatures, a battery 830, and a visible indicator 821. In one embodiment, the visible indicator is a light, such as that provided from a light emitting diode. During operation, the temperature sensitive device 800 will turn on a light source to provide the visible indicator 821 so that it is visible to a user. In another embodiment, the visible indicator of the temperature sensitive device 800 will change color displayed as the temperature of the steak changes. It will be appreciated that the light source can be contained within the body portion 810 and provided via a light guide to a visible indicator, which is a location away from the body 810. In one embodiment, the temperature sensitive device 800 will provide two or more different colors that correspond to different levels of doneness. In another embodiment, the temperature sensitive device 800 has a unique primary indicator that is stationary relative the body 200 and is capable of detecting only one color. This allows a user to correlate steaks to a desired level of doneness after the steak has been removed from a grill. For example, each indicator can have a unique number (1, 2, 3, . . . ) so that each steak can be uniquely identified on a grill, or on a serving plate. In another embodiment, the temperature sensitive device 800 provides two or more unique different colors that correspond to different levels of doneness, and each temperature sensitive device in a package has a unique indicator, such as 1, 2, 3 . . . and so on, such that each steak can be tracked separately.

FIG. 9 illustrates a portion of a particular temperature sensitive device 900 that is reusable. In one embodiment, the temperature sensitive device 900 includes an outer body portion 901, an extension portion 902 of an indicator portion that includes a primary indicator as described previously (not shown), and a release mechanism. The release mechanism includes a metal portion, labeled steel 903, a coil 904, a magnet 905, and a fit socket 906.

The metal portion 903 is located within the outer body portion 901, and is connected to a proximate end of the indicator portion. Note that a primary indicator of the indicator portion is located at a distal end of the indicator portion and as described above, may always remain external the body portion of the device. Coil 904 can be compressed by pushing the indicator portion further into the outer body 202. As the indicator portion is pushed further into the outer body 202, the magnetic attraction between the metal portion 903 and the magnet 905 becomes greater until the magnetic attraction is sufficient to hold the metal portion 903 in place against magnet 905, referred to as the loaded position. A coil resides within the outer body 902 between the metal portion 903 and the magnet 905. In the loaded position, a proximate end of the coil is in contact with the fit socket 906, and a distal end of the coil is in contact with the metal portion 903. One or more of the characteristics of one or more of the metal portion 903, coil 904 and magnet 905 are selected set a predefined temperature and tolerance range. For example, the predefined temperature can be determined by: selection of the material type of the metal portion 903; the material type of the coil 904; the material type of the magnet 905; a contact area between the metal portion 903 and the magnet 905; a length of the coil; a spring constant of the spring; the like; and combinations thereof. The fit socket 906 ensures proper placement of the magnet 905 within the outer body.

During operation, the force provided by the coil between the metal portion 903 and the fit socket, as compared to the attraction between the metal portion 903 and the fit socket 906, changes over temperature such that the indicator is extended as described above. Note that in one embodiment, the coil will have sufficient length to hold the indicator at its fully extended location. However, in another embodiment, the coil is shorter than the extension length, but results in sufficient force during release to ensure the indicator is fully extended. A coil shorter than the extension length is acceptable in accordance with the present embodiment, wherein the temperature sensitive device is inserted into steaks such that it pops-out in a direction substantially perpendicular to the gravitational force, and remains at its substantially fully extended position. Otherwise, the indicator portion of the temperature sensor would “fall” back into the outer body 902 if placed in a direction substantially parallel to the gravitation force. At least one version of a temperature sensor device based upon this design is available from

### Ningbo Makewell International Trading Co., LTD.

Room 1206-1208, No. 2 building, Shandong Business center,

### 1926 Canghai Road, Jiangdong, Ningbo, Zhejiang 315040

The description of the invention set forth herein is illustrative, and is not intended to limit the scope of the invention as set forth in the following claims. For example, except as otherwise indicated, or necessary to implement particular functions, the outer body portion, which comprises a probe portion placed into meat, and the indicator portion can be formed from 304 stainless steel to facilitate its use in high temperature environments and to facility a reusable device that is washable temperature sensitive device can be while the invention has been described in an embodiment that includes two cores, one of skill in the art will appreciate that the teachings herein can be utilized with additional cores or other processing units. Variations and modifications of the embodiments disclosed herein, may be made based on the description set forth herein, without departing from the scope and spirit of the invention as set forth in the following claims. One-time useable devices can be made using materials that facilitate forming temperature sensitive device for a lower price.

In alternate embodiments, the extension distance 41 can be greater than 0.70 inches including: greater than 0.75 inches; greater than 0.80 inches; greater than 0.85 inches; greater than 0.90 inches; greater than 0.95 inches; greater than 1.00 inches; 1.05 inches; and greater. Similarly, in the embodiment of FIG. 8, it will be appreciated that while there is no extendable portion, the portion of the probe where the light is emitted can be at a fixed distance from a flange 811, or other feature that controls placement of the temperature sensitive device within the food product, such that the location from where the light is emitted is the same as one of the extendable ranges described above. The dimension of the primary indicator can be at least 0.3 inches, least 0.4 inches, at least 0.5 inches, at least 0.6 inches. For example, the primary indicator can have a dimension that extends away from the body portion of the device by at least 0.4 inches, at least 0.5 inches, at least 0.6 inches. In an extended position, the distance from the body portion of the device and the location of the primary indicator furthest from the body is one inch or greater.

Sets of packages can be sold, wherein each package of the set includes temperature sensitive devices associated with the same level of doneness, or associated with different levels of doneness

It will be appreciated that the predefined temperature that correspond to desired levels of doneness can be different than those indicated herein depending upon various characteristics of the food being cooked, e.g., based upon different characteristics of a steak being cooked. The tolerance level for a particular predefined temperature can be +/−5 degrees, +/4 degrees, +/−3 degrees, +/−2 degrees, or +/−1 degree. All temperatures indicated herein are with reference to the Fahrenheit temperature scale.

The shapes illustrated are representative, and can vary. For example, the triangular shape could be terminated to remove the upper point and provide a four-sided polygon.

What is claimed is:

1. A temperature sensitive device comprising:
a probe portion to be inserted into food;
a release mechanism that is temperature sensitive; and
a pop-out portion including a primary indicator, the primary indicator to be retained at a retained position by the release mechanism responsive to a temperature of the probe portion being below a predefined temperature, and to extend to a released position at least 0.7 inches beyond the retained position in response to the release mechanism releasing the indicator responsive to a temperature of the probe portion being above the defined temperature.

2. A temperature sensor that in response to a temperature at a probe portion being above a defined temperature provides a visible identifier at least 0.70 inches from a probe portion of the temperature sensor.

3. The method of claim 2, wherein the at least 0.70 inches is a fixed distance relative to the probe portion.

4. The method of claim 3, wherein the visible indicator is a light.

5. The method of claim 3, wherein the visible indicator is a light provided by a light emitting diode.

6. The temperature sensor of claim 4, wherein the temperature is a first temperature, the defined temperature is a first defined temperature, and the light is a second light having a first characteristic, the temperature sensor to further in response to a second temperature at the probe portion being above a second predefined temperature proves a second light having a second characteristic.

7. The temperature sensor of claim 6, where in the first and second characteristics are visibly different characteristics including one or more of: color; intensity; and flashing interval.

8. The device of claim 2, wherein the at least 0.70 inches is an extended distance relative to the probe portion response to the temperature being above the defined temperature.

9. A set of devices comprising:
a plurality of devices, each device of the plurality having a different defined temperature from each other device of the plurality, each device including
a probe portion to be inserted into food;
a release mechanism that is temperature sensitive;
a pop-out portion including a primary indicator, the primary indicator to be retained at a retained position by the release mechanism responsive to a temperature of the probe portion being below a defined temperature, and to extend to a released position at least 0.7 inches beyond the retained position in response to a temperature of the probe portion being above the defined temperature.

10. The set of claim 9, where the set is a packaged set.

11. The set of claim 10, wherein each device of the plurality of devices in the packaged set corresponds to a different level of doneness.

12. The set of claim 11, wherein each device of the plurality of devices in the packaged set has a visibly different primary indicator that corresponds to a different level of doneness.

13. The set of claim 12, wherein the different primary indicators include visibly different colors.

14. The set of claim 12, wherein the different primary indicators include visibly different colors.

15. The set of claim 12, wherein each visibly different primary indicator corresponds to a different alphanumeric indicator.

16. The set of claim 12, wherein the different primary indicators include corresponds to a different shape.

17. The set of claim 9, wherein the food is a steak.

18. The set of claim 9, wherein each device is reusable.

19. The set of claim 18, wherein each device comprises 304 stainless steel.

20. The set of claim 9, wherein each device is one-time useable

21. The set of claim 9, wherein different primary indicators include visibly different colors.

22. The set of claim 9, wherein the pop-out portion extends to a released position of one of: at least 0.75 inches; at least 0.80 inches; at least 0.85 inches; at least 0.90 inches; at least 0.95 inches; at least 1.00 inches; and 1.05 inches.
